(19) United States
(12) Patent Application Publication
(10) Pub. No.: US 2018/0371382 A1
(43) Pub. Date: Dec. 27, 2018

(54) METHODS OF MANUFACTURING PARTICULATE FRAGRANCE ENHANCERS

(71) Applicant: Henkel IP & Holding GmbH, Duesseldorf (DE)

(72) Inventors: Geoffrey Faires, Cave Creek, AZ (US); Gulmira Imanbekova, Scottsdale, AZ (US); Leland M. Danzer, Chandler, AZ (US); Marc Maslanka, Scottsdale, AZ (US)

(73) Assignee: Henkel IP & Holding GmbH, Duesseldorf (DE)

(21) Appl. No.: 15/635,156

(22) Filed: Jun. 27, 2017

(51) Int. Cl. C11D 11/00; C11D 3/50

(52) U.S. Cl. CPC C11D 11/0088; C11D 3/505

(57) ABSTRACT

A method of manufacturing a particulate fragrance enhancer can include combining a particulate core and a binding agent in a first mixing vessel to prepare a common fragrance substrate. The common fragrance substrate can be discharged from the first mixing vessel and transferred to a second mixing vessel. A coating agent and a fragrance can be applied to the common fragrance substrate in the second mixing vessel to prepare the particulate fragrance enhancer.

### BACKGROUND

In textile washing, it is often desirable to include a fragrance to impart a pleasant scent to the washing or rinsing bath, as well as to the textile items being cleaned. To this end, many textile care compositions include a fragrance as a basic ingredient. The ability of the textile care composition to impart a pleasant scent to textiles can be an important feature to consumers when selecting a specific product. However, in some cases, the textile care composition may not include a fragrance, or may only be able to include small amounts of fragrance, which are inadequate to impart the desired scent to the textile items. In such cases, a supplemental fragrance can be added during the washing or rinsing process.

### BRIEF DESCRIPTION OF THE DRAWINGS

Invention features and advantages will be apparent from the detailed description which follows, taken in conjunction with the accompanying drawings, which together illustrate, by way of example, various invention embodiments; and, wherein:

FIG. 1 depicts a schematic of an example of a portion of a manufacturing process in accordance with an invention embodiment;

FIG. 2 depicts a schematic of an example of another portion of a manufacturing process in accordance with an invention embodiment;

FIG. 3A depicts a schematic of an example of another portion of a manufacturing process in accordance with an invention embodiment; and

FIG. 3B depicts a schematic of an example of yet another portion of a manufacturing process in accordance with an invention embodiment.

Reference will now be made to the exemplary embodiments illustrated, and specific language will be used herein to describe the same. It will nevertheless be understood that no limitation of the scope or to specific invention embodiments is thereby intended.

### DESCRIPTION OF EMBODIMENTS

Although the following detailed description contains many specifics for the purpose of illustration, a person of ordinary skill in the art will appreciate that many variations and alterations to the following details can be made and are considered to be included herein. Accordingly, the following embodiments are set forth without any loss of generality to, and without imposing limitations upon, any claims set forth. It is also to be understood that the terminology used herein is for the purpose of describing particular embodiments only, and is not intended to be limiting. Unless defined otherwise, all technical and scientific terms used herein have the same meaning as commonly understood by one of ordinary skill in the art to which this disclosure belongs.

As used in this written description, the singular forms “a,” “an” and “the” include express support for plural referents unless the context clearly dictates otherwise. Thus, for example, reference to “a polymer” or “the polymer” can include a plurality of such polymers.

In this application, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term, like “comprising” or “including,” in this written description it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. Unless otherwise stated, use of the term “about” in accordance with a specific number or numerical range should also be understood to provide support for such numerical terms or range without the term “about”. For example, for the sake of convenience and brevity, a numerical range of “about 50 angstroms to about 80 angstroms” should also be understood to provide support for the range of “50 angstroms to 80 angstroms.” Furthermore, it is to be understood that in this specification support for actual numerical values is provided even when the term “about” is used therewith. For example, the recitation of “about” 30 should be construed as not only providing support for values a little above and a little below 30, but also for the actual numerical value of 30 as well.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

Reference in this application may be made to compositions, systems, or methods that provide “improved” or “enhanced” performance. It is to be understood that unless otherwise stated, such “improvement” or “enhancement” is a measure of a benefit obtained based on a comparison to compositions, systems or methods in the prior art. Furthermore, it is to be understood that the degree of improved or enhanced performance may vary between disclosed embodiments and that no equality or consistency in the amount, degree, or realization of improvement or enhancement is to be assumed as universally applicable.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

### Example Embodiments

An initial overview of invention embodiments is provided below and specific embodiments are then described in further detail. This initial summary is intended to aid readers in understanding the technological concepts more quickly, but is not intended to identify key or essential features thereof, nor is it intended to limit the scope of the claimed subject matter.

The present disclosure is drawn to methods of manufacturing particulate fragrance enhancers. Exemplary methods can include combining a particulate core and a binding agent in a first mixing vessel to prepare a common or universal fragrance substrate. The common fragrance substrate can be discharged from the first mixing vessel and transferred to a second mixing vessel. A coating agent and first fragrance can be applied to the common fragrance substrate in the second mixing vessel to prepare the particulate fragrance enhancer. Thus, the common fragrance substrate can be a universal substrate to which different fragrances can be applied to prepare different particulate fragrance enhancers.

With this overview in mind, fragrance enhancers can generally be employed to impart a scent to textile materials. In some cases, a particular textile care composition can lack a fragrance, can lack sufficient fragrance, or can lack a fragrance of choice required to impart a desired scent to textile materials. In such cases, it can be desirable to use a fragrance enhancer in combination with the textile care composition to impart a desired and/or adequate fragrance to the textile materials.

Due to the diverse preferences of consumers, a manufacturer may need to provide a large variety of fragrance enhancers to satisfy consumer demands. This can lead to a number of complications and delays in the manufacturing process. For example, the various particulate fragrance enhancers are generally manufactured using common manufacturing equipment. Thus, when one batch of particulate fragrance enhancer material is completed, the manufacturing equipment generally requires cleaning before a different variety of fragrance enhancer can be manufactured using the same equipment. This can cause substantial delays in manufacturing while the equipment is prepared to manufacture a different variety of fragrance enhancer.

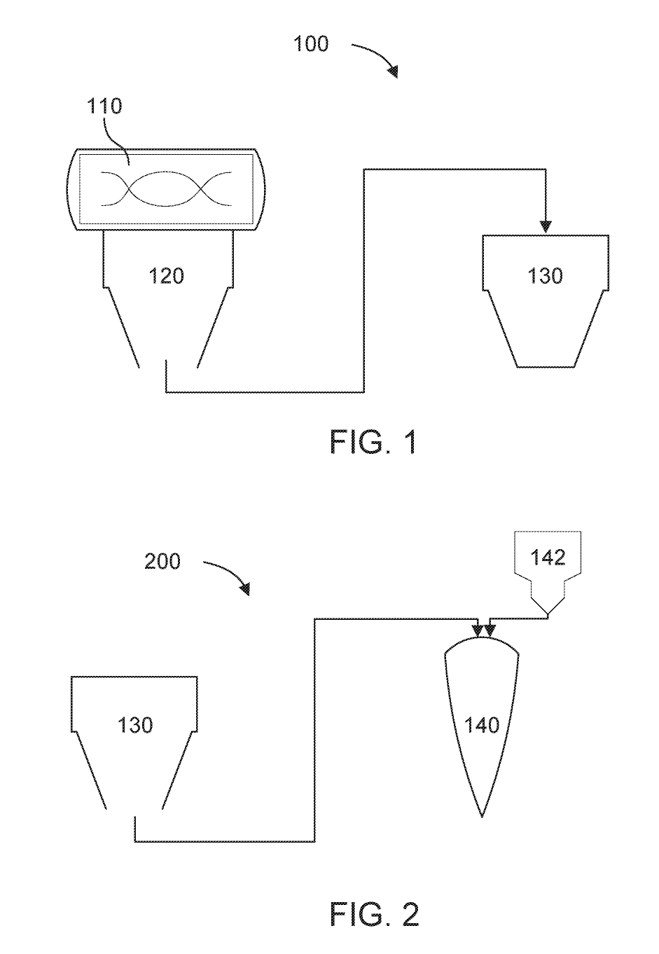

Accordingly, the present disclosure is directed to methods of manufacturing a particulate fragrance enhancer that can minimize the down-time of the manufacturing equipment and/or minimize the amount of equipment needed to manufacture a variety of particulate fragrance enhancers contemporaneously. In some examples, the method can be a semi-continuous manufacturing method that employs both a batch segment and a continuous segment. One non-limiting example of the batch segment 100 of the manufacturing method is illustrated in FIG. 1. A particulate core and a binding agent can be combined in a mixing vessel 110 to prepare a common fragrance substrate. The mixing vessel 110 can include a variety of suitable mixing vessels. Non-limiting examples can include a plow mixer, a ribbon mixer, a spiral mixer, a paddle mixer, a drum mixer, a v-blender, a conical screw mixer, or the like.

A variety of particulate core materials and binding agents can be combined in mixing vessel 110. For example, the particulate core can include inorganic alkali metal salts, organic alkali metal salts, inorganic alkaline earth metal salts, organic alkaline earth metal salts, organic acid particles, carbohydrates, silicates, urea and mixtures thereof. For example, the particulate core can include sodium chloride, potassium chloride, sodium sulfate, sodium carbonate, potassium sulfate, potassium carbonate, sodium hydrogen carbonate, potassium hydrogen carbonate, sodium acetate, potassium acetate, sodium citrate, sodium tartrate, potassium sodium tartrate, calcium chloride, magnesium chloride, calcium lactate, citric acid, tartaric acid, water glass, sodium silicate, potassium silicate, urea, dextrose, fructose, galactose, isoglucose, glucose, saccharose, raffinose, isomalt, the like, or mixtures thereof.

In further detail, in some examples, the particulate core can have a particle size of from about 0.5 mm to about 5 mm. However, in other examples, the particulate core can have a particle size of from about 0.5 mm to about 1.7 mm, or from about 1.6 mm to about 2.4 mm. The particulate core can be combined with the binding agent in a variety of amounts. In some examples, the particulate core can be combined with the binding agent in an amount so as to be present in the particulate fragrance enhancer in an amount of from about 70 wt % to about 99 wt %. However, in some examples, the particulate fragrance enhancer can be present in the particulate fragrance enhancer in an amount of from about 80 wt % to about 97 wt %, or from about 85 wt % to about 95 wt %.

The binding agent of the particulate fragrance enhancer can typically be used to help bind a variety of desirable components to the particulate core. For example, in some cases, a colorant, a corrosion inhibitor, a processing aid, an aversive agent, an anti-static agent, a fabric softening agent, an odor absorbing agent, a color stability agent, the like, or combinations thereof can be combined with the particulate core via the binding agent to prepare the common fragrance substrate. In some examples, the binding agent and one or more desirable components can be combined to form a one or more pre-mix compositions prior to combining with the particulate core. However, if the viscosity of a pre-mix composition gets too large, the coating process can become challenging. Thus, where a pre-mix composition is used, the pre-mix composition can typically have a viscosity of from about 5 centipoise (cps) to about 200 cps. In yet other examples, the pre-mix composition can have a viscosity of from about 5 cps to about 45 cps. In other examples, the binding agent and one or more desirable components can be added separately to the first mixing vessel 110 without using a pre-mix composition.

Any suitable binding agent can be used. Non-limiting examples can include propylene glycol, glycerol, butylene glycol, xylitol, sorbitol, mannitol, maltitol, polyethylene glycol, other polyols, other sugar alcohols, the like, or combinations thereof. In some examples, the binding agent can be a liquid at room temperature (e.g. about 23° C.). In other examples, the binding agent can be a solid at room temperate. Where the binding agent is a solid at room temperature, the binding agent can be further dissolved in a suitable solvent or can be melted prior to application to the particulate core.

The binding agent can be combined with the particulate core in a variety of amounts depending on the type of binding agent, the type and amount of additional components applied to the particulate core, and the like. In some specific examples, the binding agent can be combined with the particulate core in an amount so as to be present in the particulate fragrance enhancer in an amount from about 0.001 wt % to about 0.3 wt %. In yet other examples, the binding agent can be present in the particulate fragrance enhancer in an amount from about 0.003 wt % to about 0.2 wt %, or from about 0.005 wt % to about 0.1 wt %.

In some specific examples, a processing aid or flow aid can also be added to the particulate core to form the common fragrance substrate. The processing aid can be incorporated into the formulation to aid in the manufacturing process. In some examples, the processing aid can improve the conveying characteristics of common fragrance substrate, or various components thereof, during the manufacturing process, whether the product is mechanically, pneumatically, or otherwise conveyed. In some examples, the processing aid can prevent excess binding agent from coating the manufacturing equipment. In some additional examples, the processing aid can facilitate removal of the common fragrance substrate from a product container. In some further examples, the processing aid can help prevent common fragrance substrate particles from sticking together or agglomerating via the adsorption or absorption of moisture. A variety of processing aids can be included in the common fragrance substrate. Non-limiting examples can include stearates, silicates, fumed silicas, precipitated silicas, talc, encapsulated fragrance, powdered salts, the like, or combinations thereof. However, in some examples, the processing aid does not include (e.g. is substantially free of) an ecapsulated fragrance. Where included, the processing aid can be added in an amount so as to be present in the particulate fragrance enhancer an amount from about 0.05 wt % to about 5 wt %. In yet other examples, the processing aid can be present in the particulate fragrance enhancer in an amount from about 0.1 wt % to about 3 wt %. In some examples, the amount of processing aid incorporated into the particulate fragrance enhancer can be based on angle of repose. As is understood by one skilled in the art, angle of repose relates to the steepest angle from horizontal at which the particulate fragrance enhancer can be piled without slumping. In some examples, the processing aid can be included in the particulate fragrance enhancer in an amount to provide the particulate fragrance enhancer with an angle of repose from about 20 degrees to about 45 degrees. In some additional examples, the processing aid can be included in the particulate fragrance enhancer in an amount to provide the particulate fragrance enhancer with an angle of repose from about 25 degrees to about 35 degrees.

Once the particulate core, the binding agent, and any other desired components are combined in the mixing vessel 110 to prepare the common fragrance substrate, the common fragrance substrate can be discharged from the mixing vessel 110, such as into a surge vessel 120, or other suitable receptacle. Once the common fragrance substrate is discharged from the mixing vessel 110 into surge vessel 120, the mixing vessel can be immediately available to prepare a subsequent batch of common fragrance substrate. No washing of mixing vessel 110 is necessary because the common fragrance substrate is universal to a plurality of particulate fragrance enhancer products. Therefore, it can be desirable to discharge the common fragrance substrate rapidly so as to minimize equipment downtime. In some examples, the common fragrance substrate can be discharged at a rate greater than 300 pounds (lbs)/minute, 400 lbs/minute, or 500 lbs/minutes. In some specific examples, the common fragrance substrate can be discharged at a rate of from about 500 lbs/minute to about 1000 lbs/minute. Thus, multiple batches of the common fragrance substrate can be prepared without having to wash the first mixing vessel, which can allow multiple batches to be prepared in rapid succession. The amount of equipment required to prepare the common fragrance substrate can be minimized and/or equipment downtime can be minimized between batches. The product from the various batch processes can then be incorporated into the continuous segment of the manufacturing process.

In some examples, after the common fragrance substrate has been discharged from mixing vessel 110, it can be transferred to a storage silo 130, where it can await incorporation into the continuous segment of the manufacturing process. In yet other examples, the common fragrance substrate can be transferred directly to a second mixing vessel. It is emphasized that the mixing vessel 110, the surge hopper 120, the storage silo 130, and any other receptacles or conveyors employed in the manufacture and storage of the common fragrance substrate prior to transfer to the second mixing vessel need not be washed because they are all used in the manufacture of a common product. Thus, as described above, equipment demands and equipment downtime can be minimized by using a common fragrance substrate to which a variety of fragrances can be subsequently applied.

As discussed previously, the common fragrance substrate can be transferred to one or more second mixing vessels where desired fragrances, such as a first fragrance, and a coating agent can be applied to the common fragrance substrate to prepare one or more different types of particulate fragrance enhancers. The process 200 of applying the first fragrance and the coating agent to the common fragrance substrate is generally illustrated in FIG. 2. It is noted that FIG. 2 illustrates the common fragrance substrate being transferred from storage silo 130 to a second mixing vessel 140. However, as described previously, in some examples the common fragrance substrate can be transferred to the second mixing vessel 140 without the use of storage silo 130.

The second mixing vessel 140 can include a variety of suitable mixing vessels. In some examples, the second mixing vessel can be a vertical mixer. In such examples, the common fragrance substrate can typically be introduced at the top of the vertical mixer and discharged at the bottom. The mixing occurs as the product travels from the top of the vertical mixer to the bottom of the vertical mixer. Thus, a continuous feed of raw materials can be introduced into the vertical mixer, which are sufficiently mixed as they travel vertically from the top of the mixer to the bottom of the mixer, where they are discharged from the mixer. Non-limiting examples of suitable vertical mixers can include a conical mixer, a conical ribbon blender, a blending silo, or the like. However, any other suitable mixing vessel can be used.

The common fragrance substrate can typically be transferred to the second mixing vessel 140 at a reasonably rapid and continuous rate. For example, the common fragrance substrate can generally be transferred to the second mixing vessel at a rate from about 17 kilograms (kg)/minute to about 125 kg/min. In some other examples, the common fragrance substrate can be transferred to the second mixing vessel at a rate from about 50 kg/min to about 110 gk/min. The common fragrance substrate can be transferred to the second mixing vessel 140 via a flat belt conveyor, a drag chain conveyor, or other suitable conveyor. However, any suitable method of transferring the common fragrance substrate to the second mixing vessel 140 can be employed.

The rate at which the common fragrance substrate is transferred into the second mixing vessel 140 can determine the rate at which the first fragrance and coating agent are metered into the second mixing vessel 140. More specifically, the first fragrance and coating agent can be metered into the second mixing vessel 140 at ratios relative to the common fragrance substrate that will allow the first fragrance and coating agent to be present in the particulate fragrance enhancer at their respective target concentrations. As such, the first fragrance and coating agent can be metered from one or more storage containers 142 into the second mixing vessel 140 contemporaneously with the common fragrance substrate. Thus, the common fragrance substrate can be coated at target levels with the first fragrance and the coating agent to prepare the particulate fragrance enhancer.

A variety of fragrances can be employed as the first fragrance. In some embodiments, the first fragrance can be a non-encapsulated fragrance, but encapsulation of the first fragrance can be employed in some examples. Fragrances are well known in the art and the first fragrance can include any suitable fragrance or combination of fragrances. For example, fragrances can include any suitable perfume, cologne, fragrance oil, essential oil, the like, or combinations thereof. The fragrance can be formulated to have a variety of suitable top notes, middle notes, bottom notes, or combinations thereof. In short, there are many fragrances and fragrance combinations that can be used in the particulate fragrance enhancer.

In some specific examples, the first fragrance can be or can include a perfume. Any suitable perfume can be used in the particulate fragrance enhancer. The term “perfume” can refer to a variety of suitable perfume oils, fragrances, and odorants. Individual odorant compounds, e.g. the synthetic products of the ester, ether, aldehyde, ketone, alcohol, and hydrocarbon types, can be used as perfume oils or fragrances. Odorant compounds of the ester type are, for example, benzyl acetate, phenoxyethyl isobutyrate, p-tert-butyl cyclohexyl acetate, linalyl acetate, dimethyl benzyl carbinyl acetate (DMBCA), phenyl ethyl acetate, benzyl acetate, ethyl methyl phenyl glycinate, allyl cyclohexyl propionate, styrallyl propionate, benzyl salicylate, cyclohexyl salicylate, floramate, melusate, and jasmecyclate. The ethers include, for example, benzyl ethyl ether and ambroxan; the aldehydes, for example, the linear alkanals having 8 to 18 carbon atoms, citral, citronellal, citronellyl oxyacetaldehyde, cyclamenaldehyde, lilial and bourgeonal; the ketones, for example, the ionones, O-isomethyl ionone and methyl cedryl ketone; the alcohols, anethol, citronellol, eugenol, geraniol, linalool, phenylethyl alcohol and terpineol; and the hydrocarbons can include terpenes such as limonene and pinene. Thus, various mixtures of different odorants can be used in combination to produce an attractive fragrance note or combination of fragrance notes.

In some embodiments, the first fragrance can have a flash point of at least 140° F., but fragrances having a flash point below 140° F. can also be suitable in some instances. In some examples, the first fragrance can have a flash point of at least 160° F. or at least 180° F. In some specific examples, the first fragrance can have a flash point of from about 185° F. to about 212° F.

The first fragrance can be present in the particulate fragrance enhancer in a variety of amounts. The specific amount can depend on a number of factors, such as the type of fragrance employed, the desired potency of the fragrance, and the like. In some examples, the first fragrance can be present in the particulate fragrance enhancer in an amount from about 0.1 wt % to about 5 wt %. In yet other examples, the first fragrance can be present in the particulate fragrance enhancer in an amount from about 0.3 wt % to about 3 wt %, or from about 0.5 wt % to about 2.5 wt %.

The coating agent of the particulate fragrance enhancer can be used to help bind the first fragrance the common fragrance core. Any suitable coating agent can be used. Non-limiting examples can include propylene glycol, glycerol, butylene glycol, xylitol, sorbitol, mannitol, maltitol, polyethylene glycol, other polyols, other sugar alcohols, the like, or combinations thereof. In some examples, the coating agent can have the same composition as the binding agent. In some examples, the coating agent can have a different composition than the binding agent. In some examples, the coating agent can be a liquid at room temperature (e.g. about 23° C.). In other examples, the coating agent can be a solid at room temperate. Where the coating agent is a solid at room temperature, the coating agent can be further dissolved in a suitable solvent or can be melted prior to application to the particulate core.

The coating agent can be applied in a variety of amounts depending on the type of coating agent, the type and amount of the first fragrance, and the like. In some specific examples, the coating agent can be present in the particulate fragrance enhancer in an amount from about 0.001 wt % to about 0.3 wt %. In yet other examples, the coating agent can be present in an amount from about 0.003 wt % to about 0.2 wt %, or from about 0.005 wt % to about 0.1 wt %.

In some examples, the first fragrance and the coating agent can be combined to form a pre-mix composition prior to transferring into the second mixing vessel 140. In further examples, the first fragrance and coating agent can be combined with other additional components to form a pre-mix composition prior to transferring into the second mixing vessel. In yet other examples, the first fragrance and the coating agent can be added separately, but contemporaneously, to the second mixing vessel 140.

Whether or not the first fragrance and coating agent are combined prior to their addition to the second mixing vessel 140, in some examples, the first fragrance and the coating agent can be applied to the common fragrance substrate by spraying. Where this is the case, the addition rate, number of addition nozzles, mixing rate during addition, duration of mixing after coating, and other conditions can be optimized to minimize the amount of time it takes to achieve even coating of the common fragrance substrate. In some specific examples, one or more spray nozzles can be positioned to face down at a 60-80 angle from horizontal. In some examples, the spraying process can be a pulsed spraying process. Where this is the case, the pulsed spray can be timed to turn off momentarily so the first fragrance and/or coating agent is not sprayed onto the swing arm or other mixing parts of the second mixing vessel 140. Keeping the first fragrance from hitting equipment surfaces can help prevent the residual build-up of the fragrance on the equipment, making the equipment easier to clean. Thus, a wet wash of the equipment is typically not needed.

In yet other examples, the coating agent and the first fragrance can be added to the mixing vessel without spraying. In such cases, the mixing process itself can be optimized to minimize the amount of time to achieve an even coating of the particulate core.

It is further noted, as described above, that other components can likewise be added to the common fragrance substrate in the second mixing vessel 140 in addition to the coating agent and the first fragrance, as desired. Such additional components can include those describe elsewhere herein, or other suitable components. However, in some examples, application of the coating agent and the first fragrance to the common fragrance substrate in the second mixing vessel 140 can be sufficient to prepare the particulate fragrance enhancer. Where this is the case, the particulate fragrance enhancer can be transferred from the second mixing vessel 140 to a storage silo or filler (not shown).

In yet other examples, it can be desirable to add a second fragrance to the common fragrance substrate. Like the first fragrance, the second fragrance can also include any suitable perfume, cologne, fragrance oil, essential oil, the like, or combinations thereof. For example, any of the fragrance components described above with respect to the first fragrance can also be included in the second fragrance. In some examples, the first fragrance and the second fragrance can include or be the same fragrance. In some other examples, the first fragrance can include a different fragrance than the second fragrance. In some embodiments, the fragrance component (e.g. perfume, cologne, fragrance oil, essential oil, the like, or combinations thereof) of the second fragrance can be present in the second fragrance in an amount from about 5 wt % to about 30 wt %. In other examples, the fragrance component can be present in the second fragrance in an amount of from about 10 wt % to about 25 wt %.

Further, in some embodiments, the second fragrance enhancer can be an encapsulated fragrance. Encapsulation of the second fragrance can help preserve or extend the lifetime of the fragrance imparted to a particular textile from the particulate fragrance enhancer. In further detail, the second fragrance can include from about from about 70 wt % to about 95 wt % encapsulating polymer. In yet other examples, the second fragrance can include from about 75 wt % to about 85 wt % encapsulating polymer.

A variety of encapsulating polymers can be used to encapsulate the fragrance components of the second fragrance. Non-limiting examples can include gelatin, starch, melamine-urea-formaldehyde, melamine-formaldehyde, urea-formaldehyde, an acrylate polymer, a vinyl polymer, the like, or a combination thereof. In some examples, the resulting microcapsule can be water-soluble. In yet other examples, the microcapsule can be water insoluble. Further, the second fragrance can have a particle size of from about 10 microns to about 180 microns. However, in other examples, the second fragrance can have a particle size of from about 10 microns to about 100 microns.

The second fragrance can be present in the particulate fragrance enhancer in an amount from about 0.1 wt % to about 5 wt %. In yet other examples, the second fragrance can be present in the particulate fragrance enhancer in an amount from about 0.3 wt % to about 3 wt %, or from about 0.5 wt % to about 2.5 wt %. However, the ratio of the first fragrance to the second fragrance can vary depending on a variety of factors, such as desired fragrance blend, desired initial fragrance imparted to the textile, desired lifetime of the fragrance imparted to the textile, and the like. In some specific examples, the first fragrance and the second fragrance can be present in the particulate fragrance enhancer at a weight ratio of from about 1:4 to about 3:1. In yet other examples, the first fragrance and the second fragrance can be present in the particulate fragrance enhancer at a weight ratio of from about 1:3 to about 3:1, or from about 1:2 to about 2:1.

The second fragrance can be applied to the coated common fragrance substrate (i.e. the common fragrance substrate coated with the coating agent, the first fragrance, and any other desirable components) in a variety of ways. However, it is noted that the manufacturing process is performed without melting the particulate core or any other components that amount to greater than or equal to 1 wt %, 5 wt %, or 10 wt % of the particulate fragrance enhancer, such that the second fragrance is not embedded within a molten composition to protect the microcapsules from breakage during the manufacturing process. Nonetheless, the method of applying the second fragrance to the coated common fragrance substrate can be performed in a manner to minimize breakage of the polymeric encapsulation of the second fragrance. For example, in some cases, the method of applying the second fragrance can be performed in a manner such that the encapsulation of less than or equal to 50%, 40%, 35%, 30%, 25%, or 20% of the second fragrance is broken. In some specific examples, the second fragrance can be applied to the coated common fragrance substrate in combination with a processing aid or flow aid.

The second fragrance can typically be added to the coated common fragrance substrate in a continuous manner. Further, in some examples, the second fragrance can also be a universal fragrance that is added to a plurality of particulate fragrance enhancer products. This can further reduce clean-up and equipment demands.

In one specific example, the second fragrance can be applied to the coated common fragrance substrate by combining the second fragrance and the coated common fragrance substrate in a conical mixer, or equivalent. In some examples, the mixing parameters can be adjusted depending on the fragility of the polymeric encapsulation used for the second fragrance. In some examples, the second fragrance and the coated particulate core can be mixed for a period of from about 1 minute or 2 minutes to about 8 minutes, 9 minutes, or 10 minutes.

Further, in some examples, the conical mixer can employ a swing arm and/or a screw. The swing arm can be operated at a variety of speeds. In some specific examples, the swing arm can be operated at a mixing speed of from about 0.5 rpm to about 5 rpm, or from about 1 rpm to about 3 rpm. The screw can also be operated at a number of mixing speeds. In some specific examples, the screw can be operated at a mixing speed of from about 10 rpm to about 100 rpm, or from about 20 rpm to about 80 rpm.

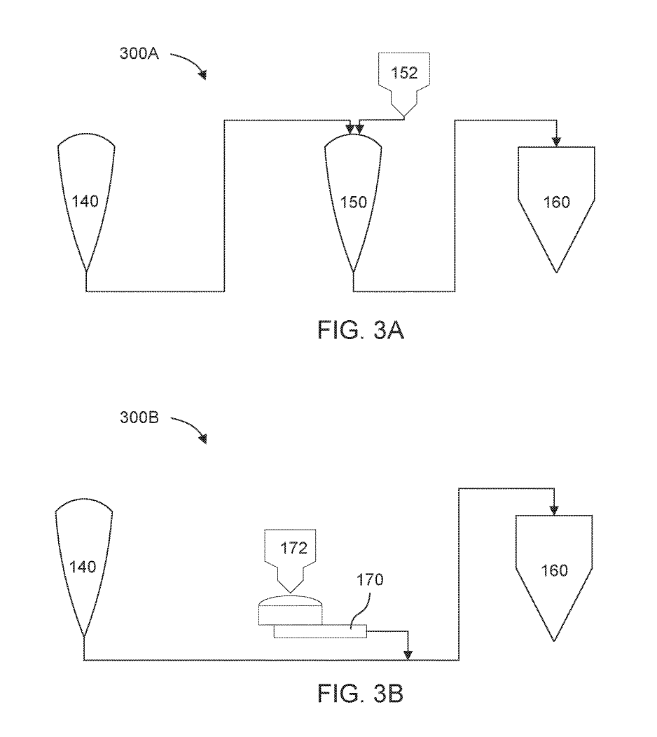

An example manufacturing process 300A employing a conical mixer is generally illustrated in FIG. 3A. The coated common fragrance substrate can be prepared in the second mixing vessel 140, as described above. In some examples, depending on the mixing parameters employed in mixing vessel 140, the second fragrance can be added concurrently with the first fragrance and coating agent in the second mixing vessel 140. However, in other examples, the coated common fragrance substrate can be transferred to a conical mixer 150. The second fragrance can be metered into the conical mixer 150 from a storage container 152 at a rate to provide the particulate fragrance enhancer with the target amount of second fragrance. The coated common fragrance substrate and the second fragrance are mixed in the conical mixer 150 to form the particulate fragrance enhancer. The particulate fragrance enhancer can then be transferred to a filler 160.

In yet another example, the second fragrance can be applied to the coated common fragrance substrate on a conveyor via a vibratory feeder. In some examples, the second fragrance and the coated common fragrance substrate can be further conveyed to a filler auger that further mixes the second fragrance and coated common fragrance substrate to form the particulate fragrance enhancer. While the filler auger can be operated at a number of mixing speeds, in some examples, the filler auger can have a mixing speed of from about 5 revolutions per minute (rpm) to about 50 rpm. In yet other examples, the filler auger can be have a mixing speed of from about 30 rpm to about 50 rpm.

An example manufacturing process 300B employing a vibratory feeder is generally illustrated in FIG. 3B. The coated common fragrance substrate can be prepared in the second mixing vessel 140, as described above. The coated common fragrance substrate can then be transferred on a conveyor towards a filler 160. A second fragrance can be metered from a storage container 172 via a vibratory feeder 170 onto the conveyor prior to the coated common fragrance substrate arriving at the filler 160. The coated common fragrance substrate and the second fragrance can be mixed as the second fragrance is metered onto the conveyor via the vibratory feeder 170 and further mixed in the filler 160 to form the particulate fragrance enhancer.

### EXAMPLES

### Example 1

### Additional of Second Fragrance via a Conical Screw Mixer

The coated common fragrance substrate was transferred to a VRIECO-NAUTA® conical screw mixer where an encapsulated fragrance was added. The conical screw mixer was operated with a variety of mixing parameters to determine the percent breakage of the polymeric encapsulation at the various mixing parameters. The results are summarized in Table 1 below:

TABLE 1

| | | | | Swing | |
|---|---|---|---|---|---|
| | Mix Time | Motor | % Encap | Arm | Screw |
| Run | (Minutes) | (Hz) | Breakage | (RPM) | (RPM) |
| 1 | 5 | 40 | 33 | 2.2 | 60 |
| 2 | 5 | 40 | 36 | 2.2 | 60 |
| 3 | 5 | 40 | 34 | 2.2 | 60 |
| 4 | 5 | 40 | 35 | 2.2 | 60 |
| 5 | 2 | 55 | 28 | 3.0 | 82.5 |
| 6 | 1 | 40 | 20 | 2.2 | 60 |
| 7 | 5 | 40 | 35 | 2.2 | 60 |
| 8 | 5 | 40 | 35 | 2.2 | 60 |
| 9 | 5 | 40 | 35 | 2.2 | 60 |
| 10 | 9 | 40 | 48 | 2.2 | 60 |
| 11 | 2 | 25 | 19 | 1.4 | 37.5 |
| 12 | 5 | 61 | 44 | 3.3 | 91.8 |
| 13 | 8 | 25 | 33 | 1.4 | 37.5 |
| 14 | 8 | 55 | 48 | 3.0 | 82.5 |
| 15 | 5 | 40 | 40 | 2.2 | 60 |
| 16 | 5 | 19 | 23 | 1.0 | 28.2 |

As can be seen in Table 1, there are a number of mixing parameters that can be employed using a conical mixer to add an encapsulated fragrance to the particulate fragrance enhancer that can minimize the amount of encapsulation breakage (i.e. maximize the number or amount of intact capsules) of the encapsulated fragrance. In each case, the amount of encapsulation breakage was reduced to below 50% breakage (i.e. capsulation integrity or intact capsules was maintained above 50%). In other cases, the encapsulation breakage was reduced to levels even below 20% breakage (i.e. capsulation integrity or intact capsules was maintained above 80%).

### Example 2

### Additional of Second Fragrance via a Vibratory Feeder

The coated common fragrance substrate was prepared and transported on a conveyor toward a filler. While en route to the filler, an encapsulated fragrance was deposited onto the conveyor with the coated common fragrance substrate. The encapsulated fragrance and coated common fragrance substrate were conveyed to a filler auger, where further mixing of the encapsulated fragrance and the coated common fragrance substrate occurred. Due to the minimal amount of shear imparted to the second fragrance using this method, it was observed that there was a 70-93% survival rate of the polymeric encapsulation after filling

It should be understood that the above-described methods are only illustrative of some embodiments of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that variations including, may be made without departing from the principles and concepts set forth herein.

What is claimed is:

1. A method of manufacturing a particulate fragrance enhancer, comprising:
combining a particulate core and a binding agent in a first mixing vessel to prepare a common fragrance substrate;
discharging the common fragrance substrate from the first mixing vessel;
transferring the common fragrance substrate to a second mixing vessel; and
applying a coating agent and a first fragrance to the common fragrance substrate in the second mixing vessel to prepare the particulate fragrance enhancer.

2. The method of claim 1, wherein the particulate core has a particle size of from about 0.5 mm to about 5 mm.

3. The method of claim 1, wherein the particulate core is a member selected from the group consisting of: inorganic alkali metal salts, organic alkali metal salts, inorganic alkaline earth metal salts, organic alkaline earth metal salts, organic acid particles, carbohydrates, silicates, urea and combinations thereof.

4. The method of claim 1, wherein the binding agent is a member selected from the group consisting of: propylene glycol, glycerol, butylene glycol, xylitol, sorbitol, mannitol, maltitol, polyethylene glycol, and combinations thereof.

5. The method of claim 1, wherein combining further comprises combining a colorant, a corrosion inhibitor, a processing aid, an aversive agent, an anti-static agent, a fabric softening agent, an odor absorbing agent, a color stability agent, or a combination thereof with the particulate core and the binding agent to form the common fragrance substrate.

6. The method of claim 1, wherein the first mixing vessel is a member selected from the group consisting of: a plow mixer, a ribbon mixer, a spiral mixer, a paddle mixer, a v-blender, a conical screw mixer, and a drum mixer.

7. The method of claim 1, wherein discharging is performed at a discharge rate of from about 500 pounds per minute to about 1000 pounds per minute.

8. The method of claim 1, wherein the common fragrance substrate is discharged into a surge vessel prior to transferring the common fragrance substrate to the second mixing vessel.

9. The method of claim 1, wherein transferring is performed at a rate of from about 17 kg/min to about 125 kg/min.

10. The method of claim 1, wherein the coating agent is a member selected from the group consisting of: propylene glycol, glycerol, butylene glycol, xylitol, sorbitol, mannitol, maltitol, polyethylene glycol, and combinations thereof.

11. The method of claim 1, further comprising mixing the coating agent and the first fragrance to form a pre-mix composition prior to applying the coating agent and the first fragrance to the common fragrance substrate.

12. The method of claim 1, wherein applying comprises spraying the coating agent, the first fragrance, or both onto the common fragrance substrate in the second mixing vessel.

13. The method of claim 12, wherein spraying is performed in a pulsed manner.

14. The method of claim 1, wherein the second mixing vessel is a vertical mixer.

15. The method of claim 14, wherein the vertical mixer is a conical mixer, a conical ribbon blender, or a blending silo.

16. The method of claim 1, further comprising applying a second fragrance to the common fragrance substrate to form the particulate fragrance enhancer, said second fragrance being an encapsulated fragrance.

17. The method of claim 16, wherein the second fragrance has a particle size of from about 10 micron to about 180 micron.

18. The method of claim 16, wherein the second fragrance is applied in a manner such that the encapsulation of less than 50% of the second fragrance is broken.

19. The method of claim 16, wherein the second fragrance is applied by adding the second fragrance to the common fragrance substrate on a conveyor via a vibratory feeder after application of the coating agent and first fragrance in the second mixing vessel.

20. The method of claim 16, further comprising applying a processing aid with the second fragrance to the common fragrance substrate to form the particulate fragrance enhancer.
